(19) United States
(12) Patent Application Publication
(10) Pub. No.: US 2021/0111612 A1
(43) Pub. Date: Apr. 15, 2021

(54) Method And Device For Twisting A Winding Head Of A Stator And Stator For An Electrical Machine

(71) Applicants: Vitesco Technologies Germany GmbH, Hannover (DE); AMEKA LTD, Sofia (BG)

(72) Inventors: Detlef Beyer, München (DE); Christoph Radtke, München (DE); Todor Paligorov, München (DE)

(73) Assignees: Vitesco Technologies Germany GmbH, Hannover (DE); AMEKA LTD, Sofia (BG)

(21) Appl. No.: 17/065,833

(22) Filed: Oct. 8, 2020

(30) Foreign Application Priority Data
Oct. 11, 2019 (EP) 19472002

(51) Int. Cl. H02K 15/02; H02K 15/04

(52) U.S. Cl. CPC H02K 15/026; H02K 15/064; H02K 15/0428

(57) ABSTRACT

Various embodiments include a method for twisting a winding head of a stator. The stator has a hollow cylindrical core with a slot on the inner surface extending between the end faces. The method includes positioning two conductors in the slot, so an end section of each conductor extends over the first end face; arranging a winding core with a cam protruding outward on the stator core; and twisting the end section of the first conductor in a peripheral direction, wherein the end section of the first conductor moves over the cam, bending a part of the end section of the first conductor in the radial direction defined by the stator core enlarging a distance between the end section of the first conductor and the end section of the second conductor measured in the radial direction of the stator core.

### CROSS-REFERENCE TO RELATED APPLICATIONS

This application claims priority to EP Application No. 19472002 filed Oct. 11, 2019, the contents of which are hereby incorporated by reference in their entirety.

### TECHNICAL FIELD

The present disclosure relates to electrical machines. Various embodiments include methods for twisting a winding head of a stator, devices for twisting a winding head of a stator, and/or stators for electrical machines.

### BACKGROUND

Methods for twisting a winding head of a stator with hairpin, or I-pin technology are well known. Usually, the stator comprises a stator core and a plurality of conductors arranged in slots of the stator core. The stator core usually comprises a plurality of lamination stacks stacked together forming the stator core. The slots are arranged on an inner surface of the stator core, extending between a first end face of the stator and a second end face of the stator being spaced to the first end face. Furthermore, the slots are arranged in peripheral direction of the stator spaced to each other.

A first row of conductors and a second row of conductors are arranged in the slots, wherein the first conductors and the second conductors are arranged in radial direction of the stator core next to each other. The conductors of the first row and the second row protrude over the first end face of the stator core. These conductor ends are twisted in peripheral direction of the stator core wherein the first conductor ends are twisted clockwise, and the second conductor ends are twisted counterclockwise. During the twisting process of the conductor ends, a coating of the conductors is stressed by friction and might crack. For avoiding any shorting, an isolation paper is placed between the first row and the second row of the conductors. However, the arrangement of an isolation paper is sometimes difficult and time consuming.

EP 1 376 818 A2 describes a method for twisting a winding head of a stator having a radial gap between the conductors. According to the described method, a tail side coil end includes a plurality of tail conductor pairs sequentially disposed with predetermined radial gaps. The radial gaps between the conductor pairs are widened near the end surface of a stator core. This arrangement prevents adjacent tail joint portions or adjacent slanting portions from undesirably contacting with each other, thereby adequately maintaining electric insulation between the tail conductor pairs and improving the space factor of the slot. However, the document does not describe how the radial gaps between the conductor pairs are widened and how this gap can be reliably shaped during and/or after the twisting process of the conductor pairs.

### SUMMARY

Teachings of the present disclosure include methods and devices for twisting a winding head of a stator, wherein the danger of shorting of the twisted conductor ends of the stator can be easily reduced. For example, some embodiments include a method for twisting a winding head of a stator (10), comprising the following steps: providing a hollow cylindrical stator core (12) having a first end face (14) and a second end face (16) being spaced apart to each other in longitudinal direction (18) of the stator core (12), and an inner surface (22) facing a longitudinal axis (18) of the stator core (12) with a least one slot (20) on the inner surface (22) extending between the first end face (14) and the second end face (16) having a slot depth (24) in radial direction of the stator core (12); positioning at least a first conductor (26) and a second conductor (28) in the slot (20) in radial direction of the stator core (12) next to each other, wherein at least an end section (42) of the conductors (26, 28) protrudes and/or extends over the first end face (14) of the stator core (12); arranging a winding core (64), having at least one cam (70) protruding in radial direction outward of the winding core (64), on the stator core (12) and/or the first end face (14); and twisting the end section (42) of the first conductor (26) in peripheral direction of the stator core (12), wherein the end section (42) of the first conductor (26) is moved over the cam (70), bending and/or necking a part of the end section (42) of the first conductor (26), between the first end face (14) of the stator core (12) and a distal end (46) of the end section (42) of the first conductor (26) facing away from the first end face (14), in radial direction of the stator core (12) in such a way, that a distance between the end section (42) of the first conductor (26) and the end section (42) of the second conductor (28) in radial direction of the stator core (12) is at least partially enlarged with respect to the distance of the first (26) and second conductor (28) in radial direction of the stator core (12), which are arranged in the slot (20).

In some embodiments, only the part of the end section (42) between the distal end (46) of the end section (42) of the first conductor (26) and the first end face (14) of the stator core (12) comprises an enlarged distance to the end section (42) of the second conductor (28) in radial direction of the stator core (12).

In some embodiments, the end section (42) of the first conductor (26) is at least partially deflected and/or bend in radial direction of the stator core (12) by a split tool (44).

In some embodiments, the deflecting step is carried out prior to the twisting step.

In some embodiments, by deflecting and/or bending the end section (42) of the first conductor (26) in radial direction of the stator core (12), the distal end (46) of the end section (42) is deflected and/or shifted into a slot (78) of a twisting tool (77) for twisting the end section (42) of the first conductor (26) in peripheral direction of the stator core (12).

In some embodiments, the end section (42) of the first conductor (26) is twisted in peripheral direction of the stator core by a twisting tool (77) having at least one slot (78) for receiving the distal end (46) of the end section (42).

In some embodiments, the twisting process is carried out time shifted to the splitting step.

As another example, some embodiments include a twisting device for twisting a winding head of a stator (10), comprising: a holding device for holding a hollow cylindrical stator core (12) having a first end face (14) and a second end face (16) being spaced apart to each other in longitudinal direction (18) of the stator core (12), and an inner surface (22) facing a longitudinal axis of the stator core (12) with a least one slot (20) on the inner surface (22) extending between first end face (14) and the second end face (16) having a slot depth (24) in radial direction of the stator core (12), wherein at least a first conductor (26) and a second conductor (28) is positioned in the slot (20) in radial direction of the stator core (12) next to each other, wherein at least an end section (42) of the conductors (26, 28) protrudes and/or extends over the first end face (14) of the stator core (12); a winding core (64), having at least one cam (70) protruding in radial direction of the winding core (64), arrangeable on the stator core (12) and/or the first end face (14) of the stator core (12) in such a way that the cam (70) is positioned next to the protruding end section (42) in peripheral direction of the stator core (12); and a twisting tool (77) having at least one slot (78) for receiving a distal end (46) of the end section (42) of the first conductor (26) facing away from the first end face (14) for twisting the end section (42) of the first conductor (26) in peripheral direction of the stator core (12), wherein by twisting the end section (42) of the first conductor (26) in peripheral direction of the stator core (12), the end section (42) of the first conductor (26) is moved over the cam (70), bending and/or necking the end section (42) of the first conductor (26) radially outward in such a way, that a distance between the end section (42) of the first conductor (26) and the end section (42) of the second conductor (28) in radial direction of the stator core (12) is at least partially enlarged with respect to the distance of the first (26) and second conductor (28) in radial direction of the stator core (12), which are arranged in the slot (20).

In some embodiments, the cam (70) comprises a sliding surface (76) arranged and configured in such a way that by twisting the end section (42) of the first conductor (26) in peripheral direction of the stator core (12), the end section (42) is at least partially moved over the sliding surface (76) and thereby at least partially bend radially outward.

In some embodiments, the winding core (64) comprises on an outer shell surface (66) a conductor guiding structure (68) on which the at least one cam (70) is arranged, wherein the conductor guiding structure (68) comprises a conductor groove (72) extending in longitudinal direction (74) of the winding core (64) for receiving the second conductor (28).

In some embodiments, there is a split tool (44) with a tooth shaped end (54) in longitudinal direction (56) of the split tool (44), wherein the tooth shaped end (54) comprises at least one receiving slot (58) for receiving the distal end (46) of the end section (42) of the first conductor (26) and a protrusion (60) next to the receiving slot (58) in peripheral direction of the split tool (44) having a sliding surface (62) arranged and designed in such a way, that when turning the split tool (44) in peripheral direction relative to the stator core (12), the distal end (46) of the end section (42) of the first conductor (26) received in the receiving slot (58) slides over the sliding surface (62) bending the end section (42) of the first conductor (26) radially outward.

In some embodiments, the slot (78) of the twisting tool (77) is open on an inner surface facing the longitudinal axis of the twisting tool (77) respectively the end section (42) of the first conductor (26).

In some embodiments, the split tool (44) comprises an insertion opening (80) on an outer shell surface (82) of the split tool (44) for receiving a turning lever, and the twisting tool (77) comprises an insertion slit (84), larger than the insertion opening (80) of the split tool (44), designed in such a way that an tuning lever can reach through the insertion slit (84) into the insertion opening (80).

As another example, some embodiments include a stator (10) for an electrical machine, comprising: a hollow cylindrical stator core (12) having a first end face (14) and a second end face (16) being spaced apart to each other in longitudinal direction (18) of the stator core (12), and an inner surface (22) facing a longitudinal axis of the stator (18) core with a least one slot (20) on the inner surface (22) extending between first end face (14) and the second end face (16) having a slot depth (24) in radial direction of the stator core (12) radially outward facing, at least a first conductor (26) and a second conductor (28) arranged in the slot (20) in radial direction of the stator core (12) next to each other, wherein at least an end section (42) of the conductors (26, 28) protrudes over the first end face (14) of the stator core (12), wherein the end section (42) of the first conductor (26) is twisted in peripheral direction of the stator core (12) in a first direction and the end section (42) of the second conductor (28) is twisted in peripheral direction of the stator core (12) in a second direction which is in opposite direction of the first direction, and at least a part of the end section (42) of the first conductor (26) between the first end face (14) of the stator core (12) and a distal end (46) of the end section (42) facing away from the first end face (14) is bend and/or necked in radial direction of the stator core (12) outward in such a way, that a distance between the end section (42) of the first conductor (26) and the end section (42) of the second conductor (28) in radial direction of the stator core (12) is at least partially enlarged with respect to the distance of the first (26) and second conductor (28) in radial direction of the stator core (12), which are arranged in the slot (20).

In some embodiments, only the part of the end section (42) between the distal end (46) of the end section (42) of the first conductor (26) and the first end face (14) of the stator core (12) comprises an enlarged distance to the end section (42) of the second conductor (28) in radial direction of the stator core (12).

### BRIEF DESCRIPTION OF THE DRAWINGS

Various aspects of the teachings of the present disclosure will be apparent from and elucidated with reference to the embodiments as per the drawings described hereinafter. In the following description, exemplary embodiments of the teachings herein are explained with reference to the accompanying schematic drawing, wherein:

FIGS. 1 to 7 illustrate a longitudinal cross section through a stator incorporating teachings of the present disclosure showing the steps for twisting the winding head of the stator;

FIG. 8 illustrates a three-dimensional view of a split tool incorporating teachings of the present disclosure;

FIG. 9 illustrates a three-dimensional view of a winding core incorporating teachings of the present disclosure;

FIG. 10 illustrates a three-dimensional view of the stator with a winding core and a split tool incorporating teachings of the present disclosure; and

FIG. 11 illustrates a three-dimensional view of the stator with a winding core, a split tool, and a twisting tool incorporating teachings of the present disclosure.

### DETAILED DESCRIPTION

In some embodiments, there is a method for twisting a winding head of a stator is provided, comprising the following steps: providing a hollow cylindrical stator core having a first end face and a second end face being spaced apart to each other in longitudinal direction of the stator core, and an inner surface facing a longitudinal axis of the stator core with a least one slot on the inner surface extending between the first end face and the second end face having a slot depth in radial direction of the stator core; positioning at least a first conductor and a second conductor in the slot, arranged in radial direction of the stator core next to each other, wherein at least an end section of the conductors protrudes over the first end face of the stator core; arranging a winding core, having at least one cam protruding in radial direction outward of the winding core, on the stator, the stator core and/or the first end face; and twisting the end section of the first conductor in peripheral direction of the stator core, wherein the end section of the first conductor is moved over the cam, bending and/or necking a part of the end section of the first conductor, between the first end face of the stator core and a distal end of the end section facing away from the first end face, in radial direction of the stator core in such a way, that a distance between the end section of the first conductor and the end section of the second conductor in radial direction of the stator core is at least partially enlarged with respect to the distance of the first and second conductor in radial direction of the stator core, which are arranged in the slot.

In some embodiments, the method results in a hollow cylindrical stator core. Usually, the stator core comprises a plurality of lamination stacks, arranged next to each other, forming the stator core. The stator core comprises a first end face and a second end face, wherein the first end face is spaced apart to the second end face in longitudinal direction of the stator core. The longitudinal direction of the stator core corresponds to the longitudinal axis of the cylindrical stator core. At least a slot is arranged on an inner surface of the stator core facing the longitudinal axis of the stator core, wherein the slot extends between the first end face and the second end face having a slot depth in radial direction of the stator core. In some embodiments, the stator core comprises a plurality of slots on the inner surface, wherein the slots are spaced to each other in peripheral direction of the stator core.

At least a first conductor and a second conductor are arranged in the slot in radial direction of the stator core next to each other. In other words, the first conductor is arranged on an imaginary first circle having its circle center on the longitudinal axis of the stator core. The second conductor is arranged on an imaginary second circle, having a diameter smaller than the first circle, and having its circle center on the longitudinal axis of the stator core. At least an end section of the first conductor and an end section of the second conductor protrude and/or extend over the first end face of the stator core.

In some embodiments, there is a plurality of first conductors and a plurality of second conductors. In some embodiments, the plurality of first conductors is arranged in peripheral direction of the stator core on the first imaginary circle, wherein the plurality of first conductors defines a first conductor row. The plurality of first conductors might be arranged next to each other and/or spaced apart to each other in peripheral direction of the stator core. The plurality of the first conductors can be arranged in such a way that only one conductor of the first conductors is arranged in the slot of the stator core. However, it is also possible that more than one first conductor is arranged in the slot of the stator core in peripheral direction of the stator core.

In some embodiments, the plurality of second conductors is arranged in peripheral direction on the first imaginary circle, wherein the plurality of second conductors defines a second conductor row. In some embodiments, the plurality of second conductors is arranged next to each other and/or spaced apart to each other in peripheral direction of the stator core. The plurality of the second conductors can be arranged in such a way that only one conductor of the second conductors is arranged in the slot of the stator core. However, it is also possible that more than one second conductor is arranged in the slot of the stator core in peripheral direction of the stator core.

A winding core is arranged on the stator, the stator core, and/or the first end face of the stator core. In other words, the winding core is arranged on the stator core resp. the end face in longitudinal direction of the stator core. The winding core might have a cylindrical or a hollow cylindrical structure and/or shape. The winding core comprises at least one cam. In some embodiments, the cam protrudes in radial direction outwardly. However, it is also possible that the cam protrudes in radial direction inwardly. In some embodiments, the winding core comprises a plurality of cams wherein the cams are spaced to each other in peripheral direction of the winding core. The winding core can also be named as a necking tool.

After arranging the winding core on the stator, resp. the end face of the stator core, the end section of the first conductor is twisted in peripheral direction of the stator core. Due to that twisting process, the end section of the first conductor is moved over the cam, wherein a part of the end section of the first conductor, between the first end face of the stator core and a distal end of the end section of the first conductor facing away from the first end face, is bend and/or necked in radial direction of the stator core in such a way, that a distance between the end section of the first conductor and the end section of the second conductor in radial direction of the stator core is at least partially enlarged with respect to the distance of the first and second conductor in radial direction of the stator core, which are arranged in the slot. Thus, due to the winding core and especially the cam arranged on the winding core, the end section of the first conductor is bend and/or necked either in radial direction outwardly or in radial direction inwardly, enlarging the radial gap between the end section of the first conductor and the end section of the second conductor. Hence, the danger of shorting of the twisted conductor ends of the stator can be easily reduced.

In some embodiments, the conductors have a rectangular shape in a cross section. However, the conductors can also have a round shape or any other type of cross section.

In some embodiments, the winding core resp. the necking tool is only used for the twisting process for bending and/or necking the end section of the first conductor. After twisting the end section of the first conductor in peripheral direction of the stator core, the winding core is removed from the stator.

In some embodiments, only the part of the end section between the distal end of the end section of the first conductor and the first end face of the stator comprises an enlarged distance to the end section of the second conductor in radial direction of the stator core. For example, the radial distance between the distal end of the first conductor and the distal end of the second conductor corresponds to the radial distance of the first conductor and the second conductor being arranged in the slot and only the twisted part of the end section of the first conductor between the distal end and the first end face of the stator is bend and/or necked radially outward providing an enlarged gap in radial direction to the respective part of the end section of the second conductor. Hence, the distal ends of the first conductor and the second conductor can be electrically connected easily.

In some embodiments, the end section of the first conductor is at least partially deflected and/or bend in radial direction of the stator core by a split tool. In some embodiments, the end section of the first conductor is deflected and/or bend over its total length in radial direction outwardly. The split tool is inserted in longitudinal direction of the stator core between the end section of the first conductor and the end section of the second conductor. Due to a movement of the split tool in peripheral direction relative to the stator core, the end section of the first conductor is at least partially bend in radial direction outwardly. In some embodiments, the deflecting step is carried out prior to the twisting step. Hence, by deflecting and/or bending the end section of the first conductor in radial direction of the stator, the distal end of the end section can be shifted into a slot of a twisting tool for twisting the end section of the first conductor in peripheral direction of the stator core.

The split tool might be arranged and designed in such a way that the end section of the first conductor is deflected and/or bend over its total length in radial direction outwardly. In some embodiments, the split tool is designed as a split ring. The split ring can be easily arranged between the end section of the first conductor and the end section of the second conductor and shifted in peripheral direction of the stator core for deflecting the end section of the respective conductor in radial direction.

In some embodiments, the end section of the first conductor is twisted in peripheral direction of the stator core by a twisting tool having at least one slot for receiving the distal end of the end section. In some embodiments, the twisting tool comprises a plurality of slots being spaced apart in peripheral direction of the twisting tool, wherein the slots are arranged and configured for receiving the distal ends of the end sections of the conductors of the first conductor row.

In some embodiments, the at least one slot comprises an opening on an end surface of the twisting tool facing the distal end of the end section of the first conductor. Such a slot, having only one opening at the end surface of the twisting tool is called a closed slot. Hence, after the end section of the first conductor is deflected in radial direction, the twisting tool is positioned in such a way that the end of the first conductor enters at least partially the slot via the opening. After entering into the slot, the twisting tool is twisted in peripheral direction of the stator core.

In some embodiments, the slot is configured as a cut. Preferably, the cut reaches through the wall thickness of the hollow cylindrical twisting tool. Such a slot is called an open slot. Hence, for example, the twisting tool is arranged on the end section of the first conductor before deflecting the end section in radial direction outwardly. After deflecting the end section of the first conductor in radial direction outwardly, the distal end of the end section of the first conductor is deflected and/or shifted into the open slot of the twisting tool. After entering the slot by the defection of the end section of the first conductor end, the twisting tool is twisted in peripheral direction of the stator core.

In some embodiments, the twisting step is carried out time shifted to the splitting step. In other words, the splitting and/or deflecting step for at least partially deflecting the end section of the first conductor in radial direction is carried out prior to the twisting step. However, after deflecting the end section of the first conductor radially outward in such a way that the distal end of the end section of the first conductor is defected and/or shifted into the open slot of the twisting tool, the split tool and the twisting tool are twisted together, respectively simultaneously, in the same direction.

In some embodiments, the stator comprises further conductors resp. conductor rows. In some embodiments, the stator comprises a third conductor and a fourth conductor. In other words, the third conductor is arranged on an imaginary third circle having its circle center on the longitudinal axis of the stator core. The diameter of the imaginary third circle is smaller than the diameter of the imaginary second circle of the second conductors. The fourth conductor is arranged on an imaginary fourth circle having the same circle center as the imaginary third circle, wherein the diameter of the fourth circle is smaller than the diameter of the imaginary third circle.

In some embodiments, a plurality of third conductors and a plurality of fourth conductors are provided. The third conductors arranged in peripheral direction of the stator core spaced to each other on the third imaginary circle, wherein the plurality of third conductors defines a third conductor row. The fourth conductors are arranged in peripheral direction of the stator core spaced to each other on the fourth imaginary circle, wherein the plurality of fourth conductors defines a fourth conductor row.

In some embodiments, the plurality of third conductors is arranged in peripheral direction of the stator core on the third imaginary circle, wherein the plurality of third conductors defines a third conductor row. In some embodiments, the plurality of third conductors is arranged next to each other and/or spaced apart to each other in peripheral direction of the stator core. The plurality of the third conductors can be arranged in such a way that only one conductor of the third conductors is arranged in the slot of the stator core. In some embodiments, more than one third conductor is arranged in the slot of the stator core in peripheral direction of the stator core.

In some embodiments, the plurality of fourth conductors is arranged in peripheral direction of the stator core on the fourth imaginary circle, wherein the plurality of fourth conductors defines a fourth conductor row. In some embodiments, the plurality of fourth conductors is arranged next to each other and/or spaced apart to each other in peripheral direction of the stator core. The plurality of the fourth conductors can be arranged in such a way that only one conductor of the fourth conductors is arranged in the slot of the stator core. In some embodiments, more than one fourth conductor is arranged in the slot of the stator core in peripheral direction of the stator core.

The first conductor, the second conductor, and the third conductor can be deflected and/or twisted according to the above described method wherein, for deflecting and or twisting the respective conductor and/or conductor row, the diameter of the winding core, split tool and/or twisting tool has to be adjusted respectively different tools have to be used.

In some embodiments, there is a twisting device for twisting a winding head of a stator, comprising: a holding device for holding a hollow cylindrical stator core having a first end face and a second end face being spaced apart to each other in longitudinal direction of the stator core, and an inner surface facing a longitudinal axis of the stator core with a least one slot on the inner surface extending between first end face and the second end face having a slot depth in radial direction of the stator core, wherein at least a first conductor and a second conductor is positioned in the slot in radial direction of the stator core next to each other, wherein at least an end section of the conductors protrudes and/or extends over the first end face of the stator core; a winding core, having at least one cam protruding in radial direction of the winding core, arrangeable on the stator, the stator core and/or the first end face of the stator core in such a way, that the cam is positioned next to the protruding end section in peripheral direction of the stator core; and a twisting tool having at least one slot for receiving a distal end of the end section of the first conductor facing away from the first end face for twisting the end section of the first conductor in peripheral direction of the stator core, wherein by twisting the end section of the first conductor in peripheral direction of the stator core, the end section of the first conductor is moved over the cam, bending the end section of the first conductor radially outward in such a way, that a distance between the end section of the first conductor and the end section of the second conductor in radial direction of the stator is at least partially enlarged with respect to the distance of the first and second conductor in radial direction of the stator core, which are arranged in the slot.

In other words, a twisting device for twisting a winding head of a stator is provided for caring out the above described twisting method, wherein the danger of shorting of the twisted conductor ends of the stator can be easily reduced. In some embodiments, the cam comprises a sliding surface arranged and configured in such a way that by twisting the end section of the first conductor in peripheral direction of the stator core, the end section is at least partially moved over the sliding surface and thereby at least partially bend radially outward for necking the first conductor. Hence, the cam comprises a ramp structure for guiding the end section of the first conductor when twisted in peripheral direction or the stator core. Thus, the turning resistance of the twisting tool in peripheral direction of the stator core can be reduced. Furthermore, the end section of the first conductor can be bend in radial direction carefully and/or gently for avoiding any damage of an isolation on the first conductor.

In some embodiments, the winding core comprises on an outer shell surface a conductor guiding structure on which the at least one cam is arranged, wherein the conductor guiding structure comprises a conductor groove extending in longitudinal direction of the winding core for receiving the second conductor. In some embodiments, the conductor guiding structure comprises a plurality of grooves and a plurality of cams, wherein the grooves and the cams are arranged alternating to each other. In other words, one groove is between two cams. The groove is designed and arranged for receiving the end section of the conductor which is not twisted by the twisting tool, wherein the end section of the conductor for twisting by the twisting tool is arranged next to the cam.

In some embodiments, the twisting devise comprises a split tool with a tooth shaped end in longitudinal direction of the split tool, wherein the tooth shaped end comprises at least one receiving slot for receiving the distal end of the end section of the first conductor and a protrusion next to the receiving slot in peripheral direction of the split tool having a sliding surface arranged and designed in such a way, that when turning the split tool in peripheral direction relative to the stator core, the distal end of the end section of the first conductor received in the receiving slot slides over the sliding surface bending the end section of the first conductor radially outward. Hence, the end section of the first conductor can be easily shifted and/or moved in radial direction of the stator core by turning the split tool relative to the stator core in peripheral direction. The end section of the first conductor slides at least partially along the sliding surface, which may be configured as a ramp. Thus, the turning resistance of the split tool can be reduced and the end section of the first conductor can be at least partially deflected in radial direction of the stator core gently.

In some embodiments, the slot of the twisting tool is open on an inner surface facing the longitudinal axis of the twisting tool, respectively facing the end section of the first conductor. Hence, the twisting tool may be arranged on the end section of the first conductor before deflecting the end section in radial direction outwardly. After deflecting the end section of the first conductor in radial direction outwardly, the distal end of the end section of the first conductor is deflected and/or shifted into the slot of the twisting tool.

In some embodiments, the split tool comprises an insertion opening on an outer shell surface of the split tool for receiving a turning lever, and the twisting tool comprises an insertion slit, larger than the insertion opening of the split tool, designed in such a way that a tuning lever can reach through the insertion slit into the insertion opening. Hence, the twisting step can be carried out time shifted to the splitting and/or deflecting step. A turning lever can reach through the insertion slit to the insertion opening. Since, the insertion slit is larger than the insertion opening, when turning the turning lever, the split tool in moved in radial direction shifting and/or deflecting the end section of the first conductor in radial direction, wherein the distal end of the end section of the first conductor introduces into the slot of the twisting tool. After the distal end section of the first conductor is received in the slot of the twisting tool, the split tool and the twisting tool are turned in peripheral direction of the stator core simultaneously by the turning lever.

In some embodiments, there is a stator for an electrical machine, preferably of an at least partially electric driven vehicle, comprising: a hollow cylindrical stator core having a first end face and a second end face being spaced apart to each other in longitudinal direction of the stator core, and an inner surface facing a longitudinal axis of the stator core with a least one slot on the inner surface extending between first end face and the second end face having a slot depth in radial direction of the stator core radially outward facing, at least a first conductor and a second conductor arranged in the slot in radial direction of the stator core next to each other, wherein at least an end section of the conductors protrudes and/or extends over the first end face of the stator core, wherein the end section of the first conductor is twisted in peripheral direction of the stator core in a first direction and the end section of the second conductor is twisted in peripheral direction of the stator core in a second direction, which is in opposite direction of the first direction, and at least a part of the end section of the first conductor between the first end face of the stator core and a distal end of the end section facing away from the first end face is bend and/or necked in radial direction of the stator core outward in such a way, that a distance between the end section of the first conductor and the end section of the second conductor in radial direction of the stator core is at least partially enlarged with respect to the distance of the first and second conductor in radial direction of the stator core, which are arranged in the slot. In other words, a stator for an electrical machine wherein the danger of shorting of the twisted conductor ends of the stator can be easily reduced.

In some embodiments, only the part of the end section between the distal end of the end section of the first conductor and the first end face of the stator core comprises an enlarged distance to the end section of the second conductor in radial direction of the stator core. For example, the radial distance between the distal end of the first conductor and the distal end of the second conductor corresponds to the radial distance of the first conductor and the second conductor being arranged in the slot and only the twisted part of the end section of the first conductor between the distal end and the first end face of the stator core is bend radially outward providing an enlarged gap in radial direction to the respective part of the end section of the second conductor. Hence, the distal ends of the first conductor and the second conductor can be easily connected.

The features and advantages of the methods described herein also apply to the devices and the stators. The features and advantages of the devices also apply to the methods and the stators. Furthermore, the features and advantages of the stator also apply to the methods and the devices.

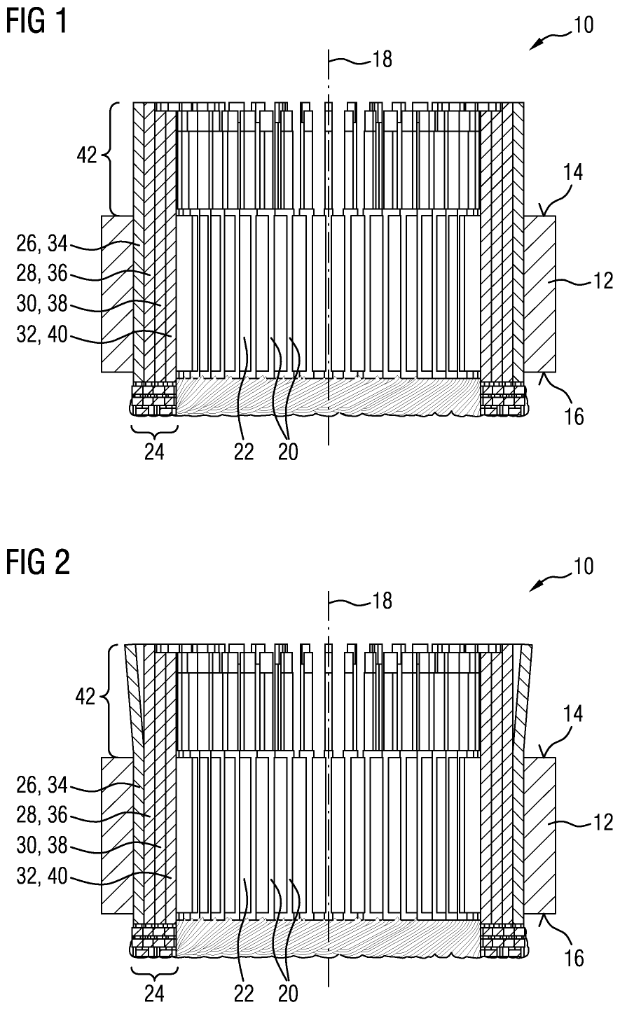

FIGS. 1 to 7 show a longitudinal cross section through a stator 10 incorporating teachings of the present disclosure, wherein the different figures show the steps for twisting the winding head 11 of the stator 10. The stator 10 comprises a hollow cylindrical stator core 12, wherein the stator core 12 comprises a first end face 14 and a second end face 16. The first end face 14 is spaced apart to the second end face 16 in longitudinal direction 18 of the stator core 12. The longitudinal direction 18 of the stator core 12 corresponds to the longitudinal axis of the cylindrical stator core 12. A least a slot 20 is arranged on an inner surface 22 facing the longitudinal axis 18 of the stator core 12, wherein the slot 20 extends between the first end face 14 and the second end face 16 having a slot depth 24 in radial direction of the stator core 12. Presently, the stator core 12 comprises a plurality of slots 20 on the inner surface 22, wherein the slots 20 are spaced to each other in peripheral direction of the stator core 12.

The stator 10 comprises at least a first conductor 26, a second conductor 28, a third conductor 30 and a fourth conductor 32 arranged in the slot 20 in radial direction of the stator core 12 next to each other. In other words, the first conductor 26 is arranged on an imaginary first circle having its circle center on the longitudinal axis 18 of the stator core 12. The second conductor 28 is arranged on an imaginary second circle, having a diameter smaller than the first circle, and having its circle center on the longitudinal axis 18 of the stator core 12. The third conductor 30 is arranged on an imaginary third circle having its circle center on the longitudinal axis 18 of the stator core 12, wherein the diameter of the imaginary third circle is smaller than the diameter of the imaginary second circle of the second conductors 28. The fourth conductor 32 is arranged on an imaginary fourth circle having the same circle center as the imaginary third circle, wherein the diameter of the imaginary fourth circle is smaller than the diameter of the imaginary third circle.

Presently, the first conductor 26, the second conductor 28, the third conductor 30 and the fourth conductor 32 each comprises a plurality of conductors, wherein the plurality conductors are arranged in peripheral direction of the stator core 12 spaced to each other. The plurality of first conductors 26 defines a first conductor row 34 on the imaginary first circle. The second conductors 28 are arranged in peripheral direction of the stator core 12 spaced to each other on the second imaginary circle and define a second conductor row 36. The plurality of third conductors 30 defines a third conductor row 38 and the plurality of fourth conductors 32 defines a fourth conductor row 40.

At least an end section 42 of the first, second third and fourth conductor 26, 28, 30, 32 protrudes and/or extends over the first end face 14 of the stator core 12.

FIG. 2 shows the stator 10 known from FIG. 1, wherein the end section 42 of the first conductor 26 is deflected and/or bend in radial direction of the stator core 12 by a split tool 44 according to FIG. 8. The split tool 44 is designed as a split ring and shown in FIG. 8. The end section 42 of the first conductor 26 is deflected and/or bend over its total length of the end section in radial direction outwardly.

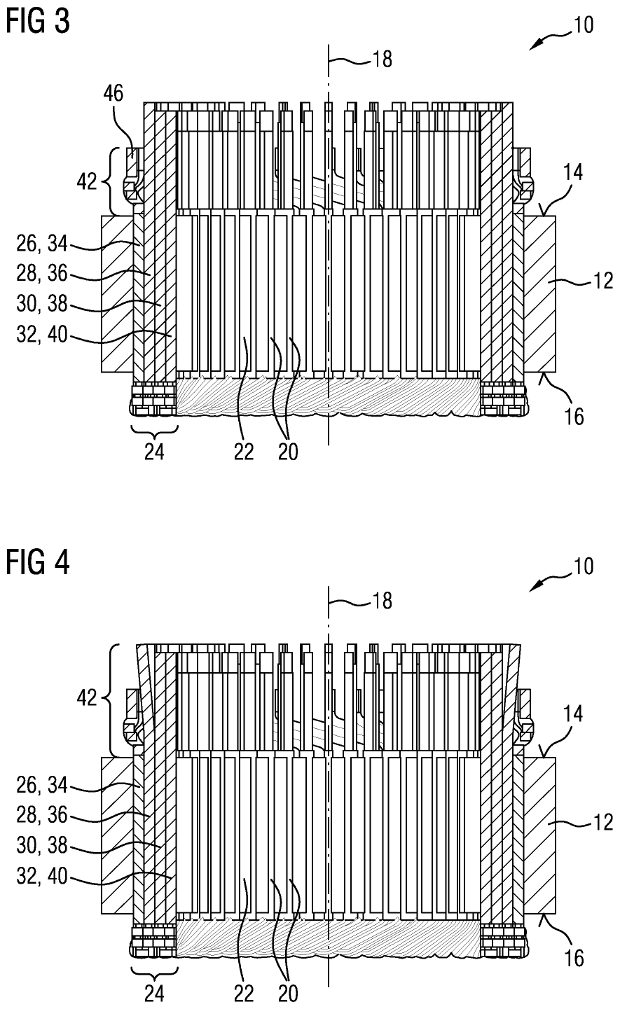

FIG. 3 show the stator 10 known from FIG. 2 wherein the end section of the first conductor 26 is twisted angular in peripheral direction of the stator core 12 in a first direction which in the present example is a counterclockwise direction according to a view in the direction of the longitudinal axis 18 of the stator core 12. At least a part of the end section 42 of the first conductor 26 between the first end face 14 of the stator core 12 and a distal end 46 of the end section 42 of the first conductor 26 facing away from the first end face 14 is bend and/or necked in radial direction of the stator core 12 outward in such a way, that a distance between the end section 42 of the first conductor 26 and the end section 42 of the second conductor 28 in radial direction of the stator core 12 is at least partially enlarged with respect to the distance of the first conductor 26 and second conductor 28 in radial direction of the stator core 12, which are arranged in the slot 20.

FIG. 4 shows the stator 10 known from FIG. 3, wherein the end section 42 of the second conductor 28 is deflected and/or bend in radial direction of the stator core 12 by the split tool 44. The Split tool 44 is shown in FIG. 8. However, the split tool 44 is different for bending end sections 42 of the different conductor rows. For example, the split tool 44 for deflecting the end section 42 of the second conductor 28 might have a smaller diameter than the one for deflecting the end section 42 of the first conductor 26.

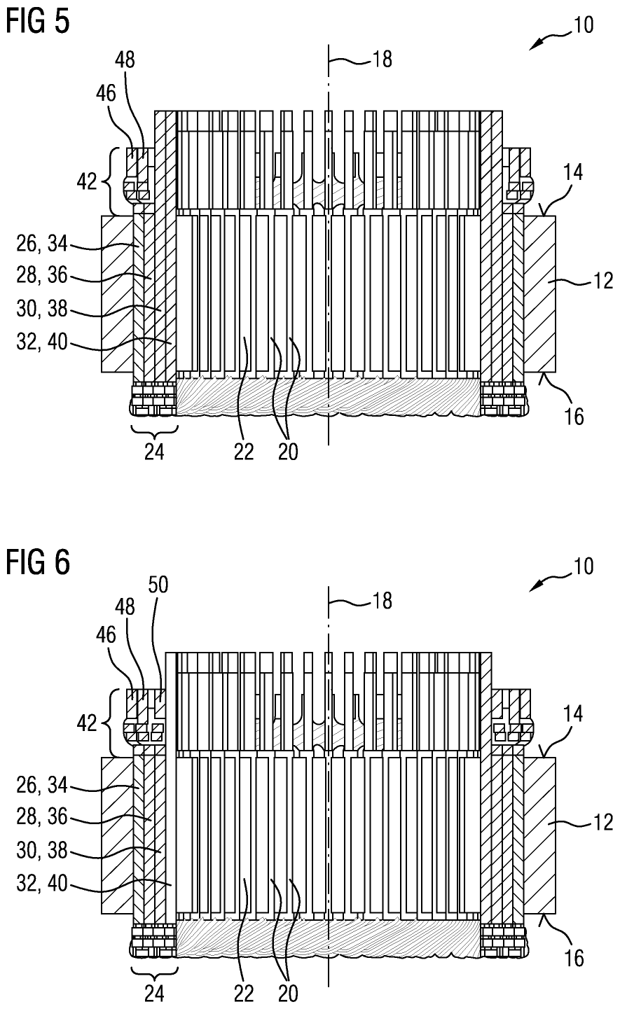

FIG. 5 shows the stator 10 known from FIG. 4, wherein the end section 42 of the second conductor 28 is twisted angular in peripheral direction of the stator core 12 in a second direction which is in the opposite direction of the first direction. The second direction is for example a clockwise direction. At least a part of the end section 42 of the second conductor 28 between the first end face 14 of the stator core 12 and a distal end 48 of the end section 42 of the second conductor 28 facing away from the first end face 14 is bend and/or necked in radial direction of the stator core 12 outward in such a way, that a distance between the end section 42 of the second conductor 28 and the end section 42 of the third conductor 30 in radial direction of the stator core 12 is at least partially enlarged with respect to the distance of the second conductor 28 and third conductor 30 in radial direction of the stator core 12, which are arranged in the slot 20.

Furthermore, only the part of the end section 42 between the distal end 46 of end section 42 of the first conductor 26 and the first end face 14 of the stator 12 comprises an enlarged distance to the end section 42 of the second conductor 28 in radial direction of the stator core 12. Hence, the radial distance between the distal end 46 of the first conductor 26 and the distal end 48 of the second conductor 28 corresponds to the radial distance of the first conductor 26 and the second conductor 28 being arranged in the slot 20 and only the twisted part of the end section 42 of the first conductor 26 between the distal end 46 and the first end face 14 of the stator core 12 is bend radially outward providing an enlarged gap in radial direction to the respective part of the end section 42 of the second conductor 28. Thus, the distal ends 46, 48 of the first conductor 26 and the second conductor 28 can be electrically connected easily.

FIG. 6 shows the stator 10 known from FIG. 5, wherein the end section 42 of the third conductor 30 is twisted in peripheral direction of the stator core 12 in the first direction, resp. counterclockwise, wherein at least a part of the end section 42 of the third conductor 30 between the first end face 14 of the stator core 12 and a distal end 50 of the end section 42 of the third conductor 28 facing away from the first end face 14 is bend and/or necked in radial direction of the stator core 12 outward in such a way, that a distance between the end section 42 of the third conductor 30 and the end section 42 of the fourth conductor 32 in radial direction of the stator core 12 is at least partially enlarged with respect to the distance of the third conductor 30 and the fourth conductor 32 in radial direction of the stator core 12, which are arranged in the slot 20. However, the end section 42 of the third conductor 30 is not deflected in radial direction of the stator core 12 by the split tool 44.

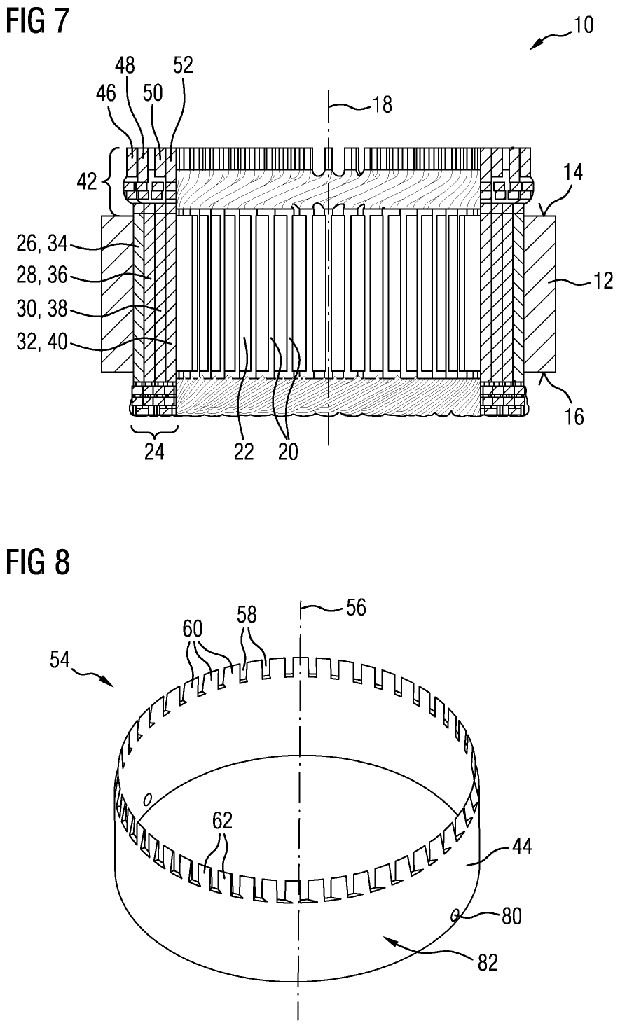

FIG. 7 shows the stator 10 known from FIG. 6, wherein the end section 42 of the fourth conductor 32 is twisted in peripheral direction of the stator core 12 in the second direction, resp. clockwise, without any bending or deflection in radial direction. Hence, the distal end 50 of the third conductor 30 can be easily connected to the distal end 52 of the fourth conductor 32.

FIG. 8 shows the split tool 44. The split tool 44, resp. split ring comprises a hollow cylindrical structure with a tooth shaped end 54 in longitudinal direction 56 of the split tool 44, wherein the tooth shaped end 54 comprises at least one receiving slot 58 for receiving the distal end 46, 48 of the end section 42 of the first conductor 26 or the second conductor 28 and a protrusion 60 next to the receiving slot 58 in peripheral direction of the split tool 44. The protrusion 60 comprises a sliding surface 62 arranged and designed in such a way, that for example when turning the split tool 44 in peripheral direction relative to the stator core 12, the distal end 46 of the end section 42 of the first conductor 26 received in the receiving slot 58 slides over the sliding surface 62 bending the end section 42 of the first conductor 26 radially outward. Hence, the end section 42 of the first conductor 26 can be shifted and/or moved in radial direction of the stator core 12 by turning the split tool 44 relative to the stator core 12 in peripheral direction of the stator core 12 easily. The end section 42 of the first conductor 26 slides at least partially along the sliding surface 62, which is preferably configured as a ramp. Thus, the turning resistance of the split tool 44 can be reduced and the end section 42 of the first conductor 26 can be at least partially deflected in radial direction of the stator core 12 gently.

The diameter of the split tool 44 is different for defecting the first conductor 26, the second conductor 28 and the third conductor 30, respectively for deflecting the first conductor row 34, second conductor row 36 and third conductor row 38.

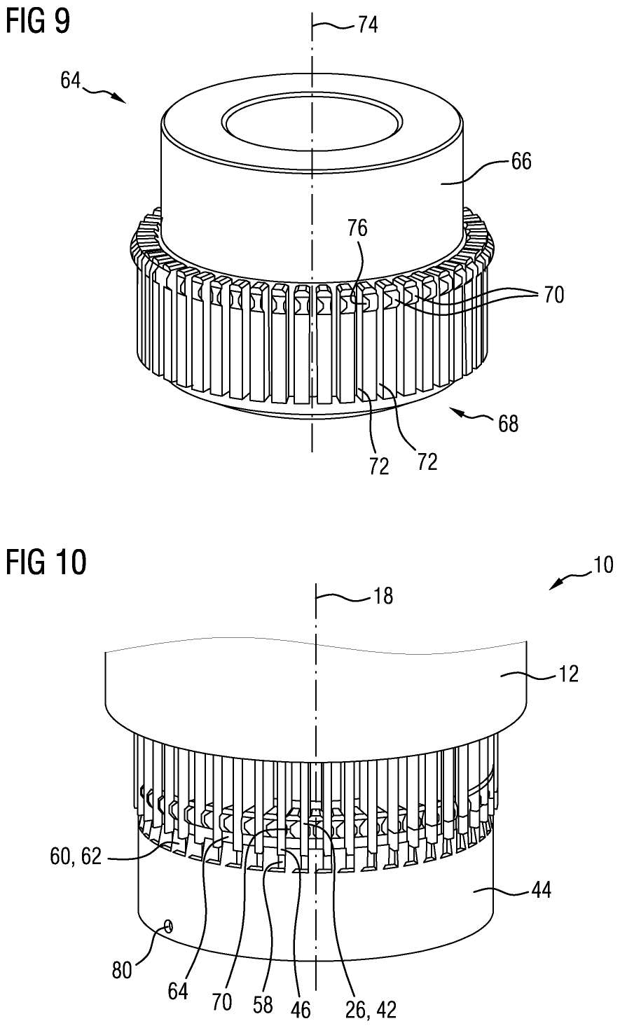

FIG. 9 shows a hollow cylindrical winding core 64. The cylindrical winding core 64 comprises on an outer shell surface 66 a conductor guiding structure 68 on which the at least one cam 70 is arranged. The conductor guiding structure 68 comprises a conductor groove 72 extending in longitudinal direction 74 of the cylindrical winding core 64 for receiving the ends sections 42 of the conductors which should not be twisted during the twisting step. Presently, conductor guiding structure 68 comprises a plurality of conductor grooves 72 and a plurality of cams 70, wherein the conductor grooves 72 and the cams 70 are arranged alternating to each other. In other words, one conductor groove 72 is between two cams 70.

The cam 70 comprises a sliding surface 76 arranged and configured in such a way that by twisting the end section 42 of the conductor to be twisted in peripheral direction of the stator core 12, the end section 42 is at least partially moved over the sliding surface 76 and thereby at least partially bend radially outward. Hence, the cam 70 comprises a ramp structure for guiding the end section of the respective conductor 26, 28, 30 when twisted in peripheral direction of the stator core 12.

The winding core 64 varies for guiding the different conductor rows of the first conductor 26, second conductor 28 and third conductor 30 at least in its diameter and the depth of the conductor groove 72 in radial direction of the cylindrical winding core 64.

FIG. 10 shows the stator 10 with the winding core 64 and the split tool 44. The winding core 64 is arranged on the stator core 12 in such a way, that the end sections 42 of the second 28, third 30 and fourth conductor 32 are guided in the conductor groove 72. The end section 42 of the first conductor 26 is arranged next to the cam 70 of the winding core 64. Furthermore, the split tool 44 is arranged on the winding core 64, wherein the distal end 46 of the end section 42 of the first conductor 26 is inserted in the receiving slot 58. When turning the split tool 44 in peripheral direction of the stator core 12, the distal end 46 of the end section 42 of the first conductor 26 slides along the sliding surface 62 of the protrusion 60, bending and/or necking the end section 42 of the first conductor 26 in radial direction of the stator core 12 outwardly.

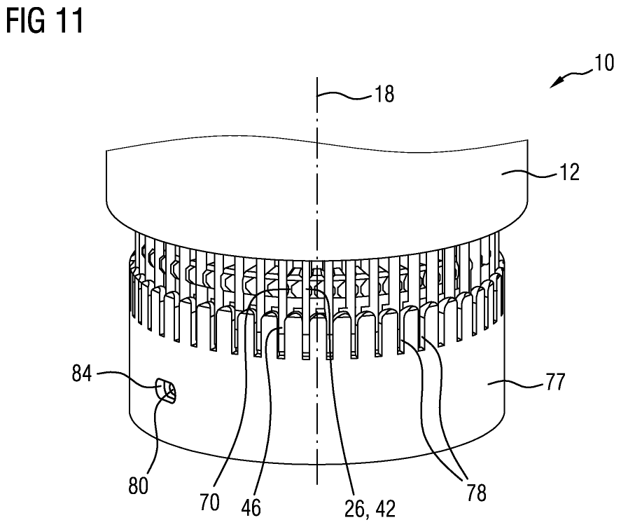

FIG. 11 shows the stator 10 known from FIG. 10 wherein a twisting tool 77 is arranged on the stator 10 respectively the end section 42 of the first conductor 26. The twisting tool comprises at least one slot 78 at a distal end facing the stator core 12 for receiving the distal end 46 of the end section 42 of the first conductor 26. The slot 78 is configured as a cut. In some embodiments, the cut reaches through the wall thickness of the hollow cylindrical twisting tool 77. Such a slot 78 is called an open slot. When deflecting the end section 42 of the first conductor 26 in radial direction outwardly, the distal end 46 of the end section 42 of the first conductor 26 is deflected and/or shifted into the open slot 78 of the twisting tool 77.

After that, the twisting tool 77 is moved in peripheral direction of the stator core 12 for twisting the end section 42 of the first conductor 26, wherein during the twisting step, the end section 42 slides along the cam 70 of the winding core 64, bending and/or necking the part of the end section 42 of the first conductor 26, between the first end face 14 of the stator core 12 and the distal end 46 of the end section 42 facing away from the first end face 14, in radial direction of the stator core 12 in such a way, that the distance between the end section 42 of the first conductor 26 and the end section 42 of the second conductor 28 in radial direction of the stator core 12 is at least partially enlarged with respect to the distance of the first 26 and second conductor 28 in radial direction of the stator core 12, which are arranged in the slot 20.

The twisting tool 77 varies for twisting the different conductor rows of the first conductor 26, second conductor 28, third conductor 30 and fourth conductor 32 at least in its diameter.

### REFERENCE SIGNS

10 Stator

12 Stator core

14 First end face of the stator core

16 Second end face of the stator core

18 Longitudinal direction/axis of the stator core

20 Slot

22 Inner surface

24 Slot depth

26 First conductor

28 Second conductor

30 Third conductor

32 Fourth conductor

34 First conductor row

36 Second conductor row

38 Third conductor row

40 Fourth conductor row

42 End section of conductor

44 Split tool

46 Distal end of end section of first conductor

48 Distal end of end section of second conductor

50 Distal end of end section of third conductor

52 Distal end of end section of fourth conductor

54 Tooth shaped end

56 Longitudinal direction of split tool

58 Receiving slot

60 Protrusion

62 Sliding surface

64 Winding core

66 Outer shell surface

68 Guiding structure

70 Cam

72 Conductor groove

74 Longitudinal direction of winding core

76 Sliding surface cam

77 Twisting tool

78 Slot

80 Insertion opening

82 Outer shell surface of split tool

1. A method for twisting a winding head of a stator, the method comprising:
providing a hollow cylindrical stator core with a first end face and a second end face spaced apart from each other in a longitudinal direction defined by the stator core, and an inner surface with a slot extending between the first end face and the second end face with a slot depth defined in a radial direction of the stator core;
positioning a first conductor and a second conductor in the slot next to each other, wherein an end section of the first conductor and an end section of the second conductor both extend over the first end face;
arranging a winding core with a cam protruding outward in a radial direction from the winding core, on the stator core; and
twisting the end section of the first conductor in a peripheral direction defined by the stator core, wherein the end section of the first conductor moves over the cam, bending a part of the end section of the first conductor, between the first end face and a distal end of the end section of the first conductor facing away from the first end face, in the radial direction defined by the stator core enlarging a distance between the end section of the first conductor and the end section of the second conductor measured in the radial direction of the stator core.

2. A method according to claim 1, wherein only a part of the end section between the distal end of the end section of the first conductor and the first end face of the stator core rests at an enlarged distance from the end section of the second conductor in the radial direction.

3. A method according to claim 1, wherein the end section of the first conductor is at least partially deflected in the radial direction of the stator core using a split tool.

4. A method according to claim 3, wherein the deflecting step is carried out prior to the twisting step.

5. A method according to claim 3, wherein, by deflecting the end section of the first conductor in the radial direction, the distal end of the end section is deflected and into a slot of a twisting tool for twisting the end section of the first conductor in a peripheral direction of the stator core.

6. A method according to claim 1, wherein the end section of the first conductor is twisted in the peripheral direction of the stator core by a twisting tool having a slot for receiving the distal end of the end section.

7. A method according to claim 1, wherein the twisting process is carried out time shifted to the splitting step.

8. A twisting device for twisting a winding head of a stator, the device comprising:
a holder for a hollow cylindrical stator core having a first end face and a second end face spaced apart from one another in a longitudinal direction defined by the stator core, and an inner surface with a slot extending between the first end face and the second end face and having a slot depth defined in a radial direction of the stator core;
wherein a first conductor and a second conductor are positioned in the slot next to each other, wherein a respective end section of each of the conductors protrudes over the first end face of the stator core;
a winding core having a cam protruding in the radial direction, the winding core arranged on the stator core so the cam is positioned next to the protruding end section in a peripheral direction of the stator core; and
a twisting tool with a slot for receiving and twisting a distal end of the end section of the first conductor facing away from the first end face;
wherein by twisting the end section of the first conductor, the end section of the first conductor moves over the cam, bending the end section of the first conductor radially outward so a distance between the end section of the first conductor and the end section of the second conductor measured in the radial direction of the stator core is at least partially enlarged.

9. A device according to claim 8, wherein the cam comprises a sliding surface arranged and configured in such a way that by twisting the end section of the first conductor in the peripheral direction of the stator core, the end section is at least partially moved over the sliding surface and thereby at least partially bent radially outward.

10. A device according to claim 8, wherein the winding core comprises:
an outer shell surface; and
a conductor guiding structure on the outer shell surface, on which the cam is arranged;
wherein the conductor guiding structure comprises a conductor groove extending in the longitudinal direction for receiving the second conductor.

11. A device according to claim 8, further comprising a split tool with a tooth shaped end including:
a receiving slot for the distal end of the end section of the first conductor; and
a protrusion next to the receiving slot in the peripheral direction of the split tool, the protrusion having a sliding surface arranged and designed in such a way, that when turning the split tool in the peripheral direction, the distal end of the end section of the first conductor in the receiving slot slides over the sliding surface, bending the end section of the first conductor radially outward.

12. A device according to claim 11, wherein the slot of the twisting tool is open on an inner surface facing the longitudinal axis of the twisting tool and the end section of the first conductor.

13. A device according to claim 8, wherein:
the split tool comprises an insertion opening on an outer shell surface for receiving a turning lever; and
the twisting tool comprises an insertion slit larger than the insertion opening, wherein an tuning lever can reach through the insertion slit into the insertion opening.

14. A stator for an electrical machine, the stator comprising:
a hollow cylindrical stator core having a first end face and a second end face spaced apart from each other in a longitudinal direction defined by the stator core, and an inner surface with a slot extending between the first end face and the second end face, the slot having a slot depth measured in a radial direction defined by the stator core;
a first conductor and a second conductor arranged in the slot next to one another, wherein at least an end section of the conductors protrudes over the first end face of the stator core;
wherein the end section of the first conductor is twisted in peripheral direction of the stator core in a first direction and the end section of the second conductor is twisted in a second direction opposite to the first direction; and
at least a part of the end section of the first conductor between the first end face and a distal end of the end section facing away from the first end face is bent in the radial direction of the stator core so a distance between the end section of the first conductor and the end section of the second conductor measured in the radial direction is at least partially enlarged.

15. A stator according to claim 14, wherein only the part of the end section between the distal end of the end section of the first conductor and the first end face comprises an enlarged distance to the end section of the second conductor.
